(19) United States
(12) Patent Application Publication
(10) Pub. No.: US 2007/0263501 A1
(43) Pub. Date: Nov. 15, 2007

(54) Protection mechanism of an optical disc drive and method thereof

(75) Inventors: Feng-fu Lin, Taipei City (TW); Yi-jen Chung, Hsinchu City (TW); Chun-wei Lin, Kao-Hsiung City (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: MediaTek Inc.

(21) Appl. No.: 11/432,277

(22) Filed: May 11, 2006

(51) Int. Cl. G11B 7/00

(52) U.S. Cl. 369/44.28; 369/44.25; 369/44.29

(57) ABSTRACT

An optical disc drive includes a pickup head for receiving a reflective light from an optical disc and detecting a reflection signal accordingly, a derived signal generator for generating a derived signal derived from the reflection signal, an envelop generator for filtering the derived signal to generate an envelop of the derived signal, and a controller for receiving the envelop of the derived signal, comparing the envelop of the derived signal with a threshold, and controlling the optical disc drive entering a protection mechanism, when the envelop crosses the threshold in a predetermined time.

### BACKGROUND OF THE INVENTION

1. Field of the Invention

The present invention relates to a slip detection and protection mechanism of an optical disc drive and method thereof.

2. Description of the Related Art

For the rewritable optical disc in DVD standard, the DVD-RAM type employs a wobbled Land/Groove recording method, which is different from the wobbled Groove recording method employed by other discs, such as CD, DVD-RW or DVD+RW. When recording, data are recorded in both the groove and land of each spiral track on the disc, therefore a high track density is obtained.

When a pickup head reads/records data from/to a DVD-RAM disc, the pickup head has to seek and then track-on a target track of the DVD-RAM disc. A tracking error (TE) signal derived from reflected light of the DVD-RAM disc is adopted to control the seeking and tracking process.

Since the polarity of TE signal is changed alternatively when tracking Land/Groove tracks, tracking the target track becomes very difficult. Track slipping after a seeking process may occur. In the prior art, after the seeking process, if the SeekOK flag is not triggered within a predetermined time, the system will let the pickup head into a track off state and enters a recovery mechanism. In the recovery mechanism, the system will re-track-on the target track. In another prior art, after the seeking process, the system will monitor the TE or TRO signals in detecting the track slipping occurrence. If the magnitude of TE signal is over a predetermined threshold in a predetermined time, the system will enter the recovery mechanism. However, a common problem existing in these two technologies is that there is a waste of time in detecting the track slipping occurrence.

Besides the TE signal, a focusing error (FE) signal generated during the pickup head tracking on the disc is also considered. If the FE and TE signals are unstable during the recording process, the system would enter a protection mechanism to recover the system. The prior art sets a threshold to detect whether the FE and TE signals are stable or not. There is time wasted in detecting the unstable TE and FE signals.

Accordingly, in order to solve such problem in the prior arts, a need for properly detecting track slipping and for executing a protection mechanism is required.

### SUMMARY OF INVENTION

Briefly summarized, the claimed invention provides an optical disc drive. The optical disc drive comprises a pickup head for receiving a reflective light from an optical disc, a derived signal generator for generating a derived signal according to the reflective light, an envelop generator for filtering the derived signal to generate an envelop of the derived signal, and a controller for receiving the envelop of the derived signal, comparing the envelop of the derived signal with a threshold, and controlling the optical disc drive entering a protection mechanism, when the envelop crosses the threshold in a predetermined time.

According to the claimed invention, a protection method for an optical disc in an optical disc drive is disclosed. The optical disc drive comprises a pickup head for receiving a reflective light from an optical disc and detecting a reflection signal. The method comprises the steps of receiving the reflection signal to generate a derived signal, filtering the derived signal to generate an envelop of the derived signal, comparing the envelop of the derived signal with a threshold, and controlling the optical disc drive entering a protection mechanism, when the envelop crosses the threshold in a predetermined time.

The disclosed invention will be described with reference to the accompanying drawings, which show important sample embodiments of the invention and which are incorporated in the specification hereof by reference.

### BRIEF DESCRIPTION OF THE DRAWINGS

FIG. 1 shows a functional block diagram of a first embodiment of an optical disc drive in accordance with the present invention.

FIG. 2 shows a functional block diagram of the envelop generator depicted in FIG. 1.

FIG. 3 illustrates input and output waveforms of respective elements shown in FIG. 2.

FIG. 4 shows a functional block diagram of a second embodiment of an optical disc drive according to the present invention.

FIG. 5 shows a flowchart of a preferred embodiment method incorporating with the optical disc drive in accordance with the present invention.

### DETAILED DESCRIPTION OF THE PREFERRED EMBODIMENT

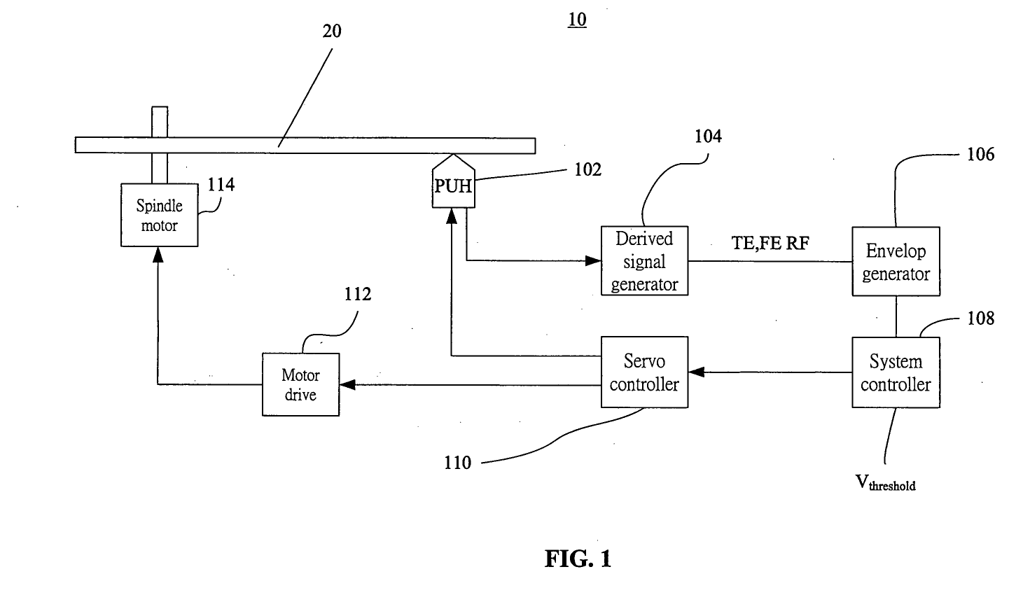

Please refer to FIG. 1, which shows a functional block diagram of an optical disc drive 10 in accordance with the first embodiment of the present invention. The optical disc drive 10 is used for reproducing and recording data from and to the optical disc 20, and comprises a pick-up head (PUH) 102, a derived signal generator 104, an envelop generator 106, a system controller 108, a servo controller 110, a motor driver 112, and a spindle motor 114.

When the disc drive 10 is operated, a light source (not shown) of the PUH 102 emits light toward the disc 20, and a photo detecting means, e.g. a sensor, (not shown) of the pickup head 102 detects reflected light from the disc 20 to produce reflective signals based on the detection. A derived signal generator 104 receives the optical signal and generates a derived signal accordingly. The derived signal maybe be a tracking error (TE) signal, a focusing error (FE) signal, a radio frequency (RF) signal, or signals derived from the TF, FE or RF signals, such as tracking error zero crossing (TEZC), radio frequency zero crossing (RFZC), radio frequency ripple (RFRP) signals, etc. Due to such derived signals are well-known to those skilled in the art, details are omitted for brevity. The envelop generator 106 is used for filtering the derived signal to generate an envelop of the derived signal. Then, the system controller 108 compares the envelop of the derived signal with a threshold, therefore controlling the optical disc drive 10 entering a protection mechanism when the envelop crosses the threshold in a predetermined time.

In one embodiment, the derived signal is a TE signal, the system controller 108 uses the envelop of the TE signal to detect whether the PUH 102 is slipping out of the target track, and the protection mechanism is to recover the system controller 108 controlling the servo controller 110 to re-track-on the target track. In another embodiment, the derived signal is a TE or FE signal, the system controller 108 uses the envelop of the TE or FE signal to detect whether the TE or FE signal is stable, and the protection mechanism is to slow down the rotational speed of the optical disc 20. In this embodiment, when the system controller 108 enters the protection mechanism to perform a re-serve-on action, the system controller 108 lets the servo controller 110 to control the motor driver 112 to slow down the spindle motor 114.

Please note that, in the other embodiment, the system controller 108 and the servo controller 110 could be integrated in one controller. In another embodiment, the system controller 108 could also perform the operation of controlling the motor driver 112 and the PUH 102. In the other embodiment, the servo controller 110 could also perform the operation of determining whether to entering the protection mechanism or not.

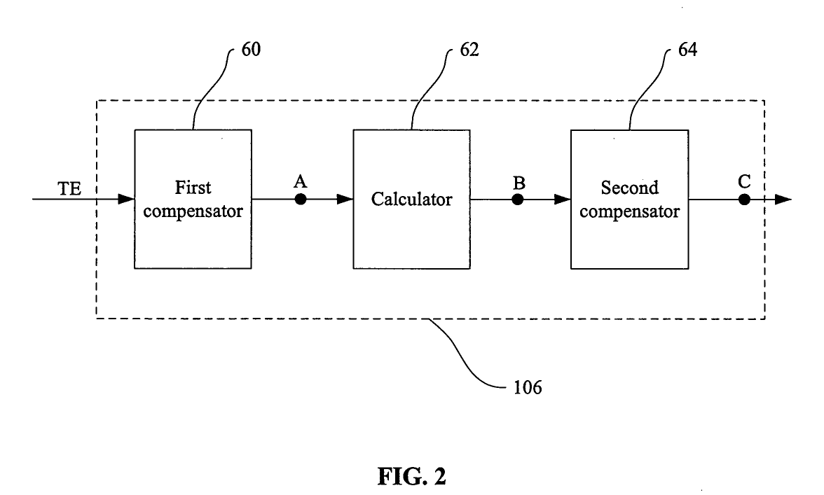

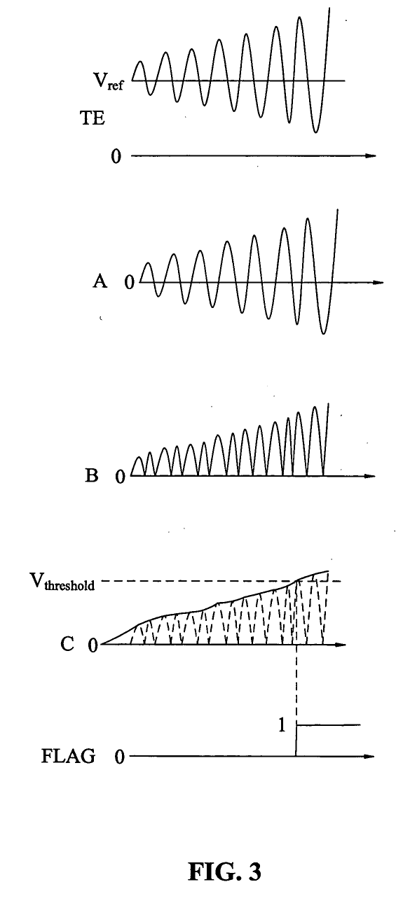

Please refer to FIG. 2 in conjunction to FIG. 3. FIG. 2 shows a functional block diagram of the envelop generator 106 depicted in FIG. 1; FIG. 3 illustrates input and output waveforms of respective elements shown in FIG. 2. The envelop generator 106 comprises a first compensator 60, a calculator 62, and a second compensator 64. Take TE signal as the derived signal, for example. The first compensator 60 which may be a high pass filter is used for eliminating a DC voltage Vref of the TE signal. Preferably, bandwidth of the first compensator 60 is in a range of 1 K-10 KHz. The calculator 62 is used for converting negative voltage component of the TE signal into positive voltage component, without the DC voltage. For example, the calculator 62 can perform a mathematical operation in square root of the square of the signal V_{A}, or in taking an absolute value of the signal V_{A}, that is, as input of the calculator 62, the signal V_{A} at node A is converted by either V_{B}=\sqrt{(V_{A})²}, or V_{B}=|V_{A}|, where V_{B} is the output of the calculator 62. Then, the second compensator 64 which may be a low pass filter or an integrator is used for extracting an envelop signal of the signal V_{B}. Preferably, bandwidth of the second compensator 64 is in a range of 500 Hz-1 KHz. The envelop signal extracted by the second compensator 64 is applied to the system controller 108. Finally, the system controller 108 compares the magnitude of the envelop signal Vc with a predetermined threshold V_{threshold}. As long as the envelop signal Vc reaches the predetermined threshold V_{threshold}, the flag of logical “1” is triggered and enables the optical disc drive 10 to track off and return to the recovery state. Otherwise, the motor driver 112 drives the spindle motor 114 to slightly adjust the position of the PUH 102. Once the system controller 108 enables the track off command for a given time period, the flag goes to logical “0” and the optical disc drive 10 restarts the track-on command again. If the optical disc drive 10 is recording data to the optical disc 20, the system controller 108 slows down a rotation speed of the optical disc drive 10.

Basically, the envelop generator 106 functions as a band pass filter. In other words, the first compensator may be a band pass filter while the second compensator may be a low pass filter, or the first compensator maybe a high pass filter while the second compensator may be a band pass filter.

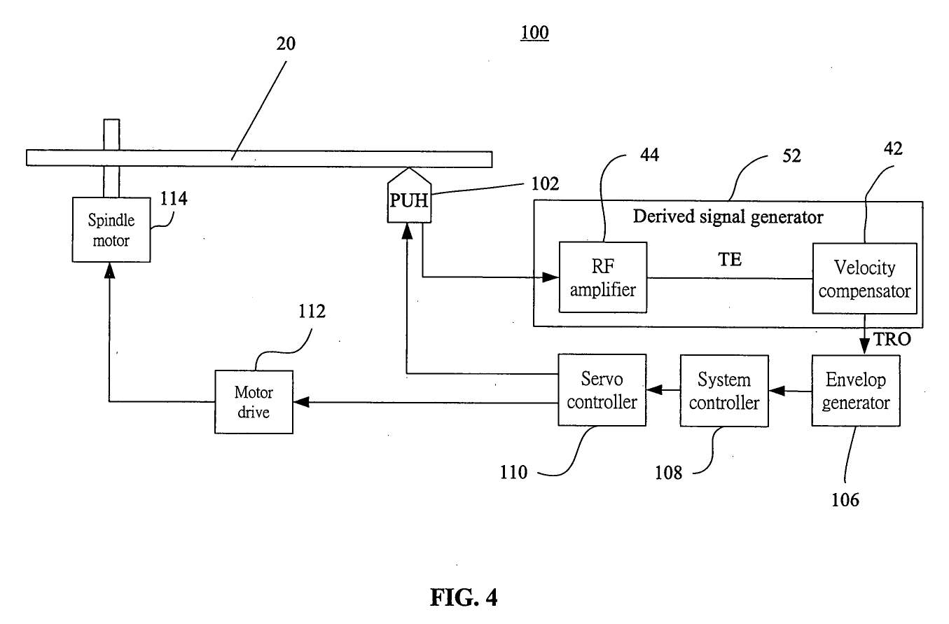

Please refer to FIG. 4, which shows a diagram of a second embodiment of an optical disc drive according to the present invention. It is noted that, for simplicity, elements in FIG. 4 having the same functions as elements illustrated in FIG. 1 are provided with the same item numbers as those in FIG. 1. Differing from the optical disc drive 10 depicted in FIG. 1, a derived signal generator 104 of the optical disc drive 100 in FIG. 4 comprises a radio frequency amplifier 44 and a velocity compensator 42. When the disc drive 100 is operated, a light source (not shown) of the PUH 102 emits light toward the disc 20, and a plurality of sensors (not shown) of the PUH 102 detects reflected light from the disc 20 to produce optical signals based on the detection. Tracking error (TE) signals is converted from the optical signal by the radio frequency amplifier 44 and fed into the velocity compensator 42. Thereafter, the velocity compensator 42 makes a velocity estimation to generate the tracking coil control (TRO) signal, as the person skilled in the art is aware. In the embodiment, output of the derived signal generator 104 is a derived signal, i.e. the TRO signal.

Similar to elements illustrated in FIG. 2, except the TRO signal in lieu of the TE signal, the envelop generator 106 is used for filtering the TRO signal to generate an envelop of the TRO signal. The system controller 108 compares the envelop of the TRO signal with a threshold V_{threshold}, and controls the optical disc drive 100 to re-track a target track of the optical disc. In addition, if the optical disc drive 100 is recording data to the optical disc 20 and the envelop of the TRO signal crosses the threshold V_{threshold}, the system controller 108 slows down a recording speed of the optical disc drive 100.

It is appreciated that, in addition to the tracking error (TE) signal and the tracking coil control (TRO) signal, a focusing error (FE) signal, which is used for tracking and has similar function as tracking error (TE) signal, can be as input of the envelop generator 106. By using mechanism mentioned above, the FE signal or other control signals associated with the FE signal or tracking error (TE) signal can be used for detecting track slipping.

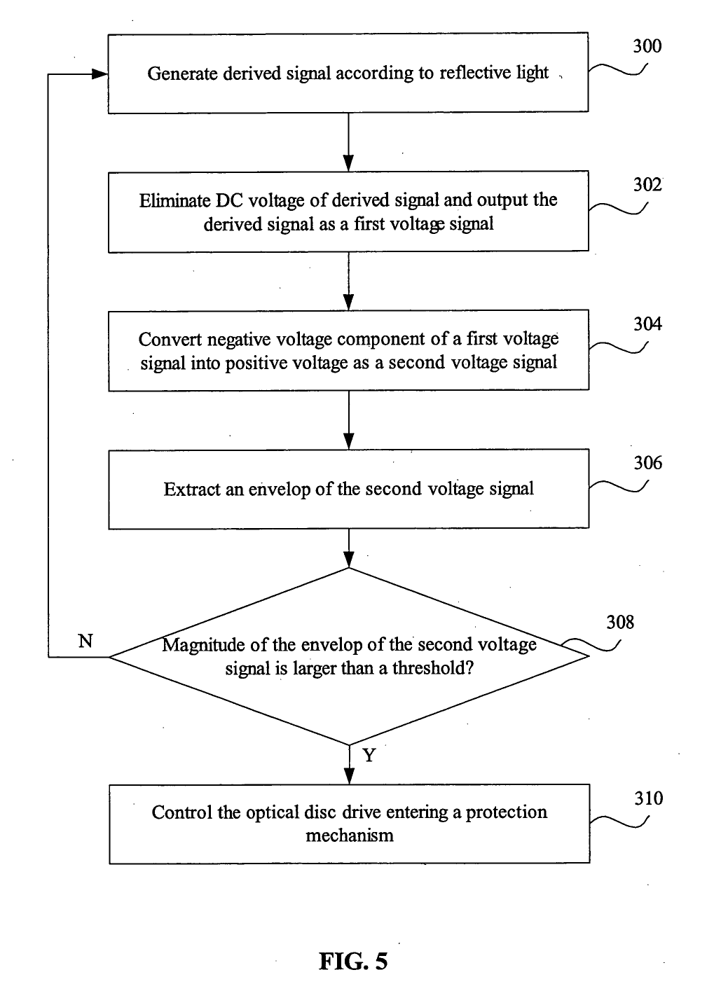

Please refer to FIG. 5. FIG.5 shows a flowchart of a preferred embodiment method incorporating with the optical disc drive in accordance with the present invention. The method of the preferred embodiment is described as follows:
Step 300: By using a derived signal generator, a derived signal (e.g. TE, FE, TRO, RF signals) is generated according to the reflective light from an optical disc.
Step 302: DC voltage of the derived signal is eliminated, and a first voltage signal indicative of the derived signal without the DC voltage is outputted.
Step 304: By performing a mathematical operation in taking the square root of squaring the tracking control signal, or performing a mathematical operation in taking an absolute value of the tracking control signal; in this manner, negative voltage component of the first voltage signal is converted into positive voltage as a second voltage signal.
Step 306: Extracting an envelop of the second voltage signal is performed.
Step 308: Determining whether magnitude of the envelop of the derived signal is larger than a threshold. If it is, go to Step 310; if not, go to Step 300.
Step 310: Controlling the optical disc drive entering a protection mechanism when the envelop crosses the threshold in a predetermined time.

As described above, in contrast to prior art, the present invention utilizes an envelop generator for, in real time, detecting track slipping during tracking. The envelop generator can eliminate a possible error of track slipping, and the controller compares the output of the envelop generator with a threshold. As long as the output of the envelop generator crosses the threshold, the system controller enables protection mechanism to slow down a rotational speed of the optical disc drive or to re-track a target track of the optical disc; therefore, preventing the optical disc drive from possibly performing meaningless track-on action. Consequently, the optical disc drive can accurately perform the tracking control.

Although the present invention has been explained by the embodiments shown in the drawings described above, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

What is claimed is:

1. An optical disc drive, comprising:
a pickup head for receiving a reflective light from an optical disc;
a derived signal generator for generating a derived signal derived from the reflective light;
an envelop generator for filtering the derived signal to generate an envelop of the derived signal; and
a controller for receiving the envelop of the derived signal;
comparing the envelop of the derived signal with a threshold; and
controlling the optical disc drive entering a protection mechanism, when the envelop crosses the threshold in a predetermined time.

2. The optical disc drive of claim 1, wherein the envelop generator further comprises:
a first compensator for eliminating DC voltage of the derived signal and for outputting a first voltage signal indicative of the derived signal without the DC voltage;
a calculator for converting negative voltage component of the first voltage signal into positive voltage and generating a second voltage signal; and
a second compensator for extracting an envelop of the second voltage signal.

3. The optical disc drive of claim 2, wherein the calculator performs a mathematical operation in square root of the square of the derived signal.

4. The optical disc drive of claim 2, wherein the calculator performs a mathematical operation in taking an absolute value of the derived signal.

5. The optical disc drive of claim 2, wherein the first compensator is a high pass filter and the second compensator is a low pass filter.

6. The optical disc drive of claim 2, wherein the first compensator is a band pass filter and the second compensator is a low pass filter.

7. The optical disc drive of claim 2, wherein the first compensator is a high pass filter and the second compensator is a band pass filter.

8. The optical disc drive of claim 2, wherein the second compensator is an integrator.

9. The optical disc drive of claim 1, wherein the derived signal is selected at least one from the group consisting of a tracking error (TE) signal, a tracking output (TRO) signal, a focusing error (FE) signal, a tracking error zero crossing (TEZC) signal, a radio frequency zero crossing (RFZC) signal, and a radio frequency ripple (RFRP) signal.

10. The optical disc drive of claim 9, wherein when the optical disc drive is performing a tracking and following process, the derived signal is the TRO signal and protecting mechanism is re-tracking on a target track of the optical disc.

11. The optical disc drive of claim 9, wherein the protection mechanism is slowing down a recording speed of the optical disc drive when the optical disc drive is recording data to the optical disc.

12. A protection method of an optical disc drive, the optical disc drive comprising a pickup head for receiving a reflective light from an optical disc, the method comprising:
generating a derived signal according to the reflective light;
filtering the derived signal to generate an envelop of the derived signal; and
comparing the envelop of the derived signal with a threshold; and
controlling the optical disc drive entering a protection mechanism, when the envelop crosses the threshold in a predetermined time.

13. The method of claim 12, wherein the step of filtering the derived signal to generate an envelop of the derived signal comprises:
eliminating a DC voltage of the derived signal and outputting a first voltage signal indicative of the tracking control signal without the DC voltage;
converting negative voltage component of the first voltage signal into positive voltage as a second voltage signal; and
extracting an envelop of the second voltage signal.

14. The method of claim 13, wherein the step of converting negative voltage of the first voltage signal into positive voltage as a second voltage signal comprises performing a mathematical operation in square root of square of the tracking control signal.

15. The method of claim 13, wherein the step of converting negative voltage of the first voltage signal into positive voltage as a second voltage signal comprises performing a mathematical operation in taking an absolute value of the tracking control signal.

16. The method of claim 12, wherein the derived signal is selected at least one from the group consisting of a tracking error (TE) signal, a tracking output (TRO) signal, a focusing error (FE) signal, a tracking error zero crossing (TEZC) signal, a radio frequency zero crossing (RFZC) signal, and a radio frequency ripple (RFRP) signal.

17. The method of claim 16, wherein when the optical disc drive is performing a tracking and following process, the derived signal is the TRO signal and protecting mechanism is re-tracking on a target track of the optical disc.

18. The method of claim 16, wherein the protection mechanism is slowing down a recording speed of the optical disc drive when the optical disc drive is recording data to the optical disc.

19. The method of claim 12, wherein the optical disc is a DVD-RAM (digital versatile disc random access memory).
